(19) United States
(12) Patent Application Publication
(10) Pub. No.: US 2014/0177133 A1
(43) Pub. Date: Jun. 26, 2014

(54) MULTILAYER CERAMIC ELECTRONIC COMPONENT

(71) Applicant: SAMSUNG ELECTRO-MECHANICS CO., LTD., Suwon (KR)

(72) Inventors: Ro Woon LEE, Suwon (KR); Young Ho KIM, Suwon (KR); Kyung Jin CHOI, Suwon (KR); Yoon Hee LEE, Suwon (KR); Ki Chun YANG, Suwon (KR)

(73) Assignee: SAMSUNG ELECTRO-MECHANICS CO., LTD., Suwon (KR)

(21) Appl. No.: 13/846,299

(22) Filed: Mar. 18, 2013

(30) Foreign Application Priority Data
Dec. 21, 2012 (KR) 10-2012-0151467

(51) Int. Cl. H01G 4/12

(52) U.S. Cl. CPC H01G 4/1209
USPC 361/321.4

(57) ABSTRACT

There is provided a multilayer ceramic electronic component, including: a ceramic body including dielectric layer; and first and second internal electrodes formed inside the ceramic body and disposed to face each other with the dielectric layer interposed therebetween, wherein, on a cross section of the ceramic body taken in length-thickness (L-T) directions thereof, a secondary phase material is formed at interfaces between the first and second internal electrodes and the dielectric layers, and a ratio of an area occupied by the secondary phase material to an overall area of the ceramic body is 0.1% to 0.5%.

### CROSS-REFERENCE TO RELATED APPLICATIONS

This application claims the priority of Korean Patent Application No. 10-2012-0151467 filed on Dec. 21, 2012, in the Korean Intellectual Property Office, the disclosure of which is incorporated herein by reference.

### BACKGROUND OF THE INVENTION

1. Field of the Invention

The present invention relates to a multilayer ceramic electronic component, and more particularly, to a multilayer ceramic electronic component having excellent reliability.

2. Description of the Related Art

Generally, electronic components using a ceramic material, such as a capacitor, an inductor, a piezoelectric element, a varistor, a thermistor, or the like, include a ceramic body formed of a ceramic material, internal electrodes formed inside the ceramic body, and external electrodes formed on surfaces of the ceramic body and electrically connected to the internal electrodes.

Among ceramic electronic components, a multilayer ceramic capacitor includes a plurality of laminated dielectric layers, internal electrodes facing each other with the dielectric layers interposed therebetween, and external electrodes electrically connected to the internal electrodes.

Multilayer ceramic capacitors have been widely used as components in computers, PDAs, mobile phones, and the like, due to advantages thereof such as miniaturization, high capacitance, ease of mounting, and the like.

In recent years, as electric and electronic devices have higher degrees of functionality and have become lighter, thinner, shorter, and smaller, electronic components have also been required to have a smaller size, higher performance, and higher capacitance. In particular, as CPU speeds are increased and devices become smaller, lighter, digitalized and high-functionalized, research into multilayer ceramic capacitors to implement improved characteristics, such as miniaturization, thinness, higher capacitance, lower impedance in a high frequency band, and the like, has actively progressed.

Meanwhile, when an inside of a general multilayer ceramic capacitor is analyzed, a secondary phase may be formed at an interface between an internal electrode and a dielectric layer.

In a case in which the secondary phase is not formed, ideal characteristics of internal electrodes and dielectric layers may be exhibited, resulting in high-dielectric characteristics being exhibited. However, the thinning of the dielectric layers and the internal electrodes unavoidably involves a reaction and a secondary phase at interfaces therebetween at the time of high-temperature sintering.

This has a significant effect on uniformity, reliability, and the like inside the multilayer ceramic capacitor.

Therefore, the secondary phase needs to be controlled in order to secure high capacitance and reliability in multilayer ceramic capacitors.

### RELATED ART DOCUMENTS

(Patent Document 1) Japanese Patent Laid-Open Publication No. 2000-269073

### SUMMARY OF THE INVENTION

An aspect of the present invention provides a multilayer ceramic electronic component having a high degree of reliability.

According to an aspect of the present invention, there is provided a multilayer ceramic electronic component, including: a ceramic body including dielectric layer; and first and second internal electrodes formed inside the ceramic body and disposed to face each other with the dielectric layers interposed therebetween, wherein, on a cross section of the ceramic body taken in length-thickness (L-T) directions thereof, a secondary phase material is formed at interfaces between the first and second internal electrodes and the dielectric layers, and a ratio of an area occupied by the secondary phase material to an overall area of the ceramic body is 0.1% to 0.5%.

The secondary phase material may include a rare earth element.

The rare earth element may be at least one selected from the group consisting of dysprosium (Dy), yttrium (Y), holmium (Ho), erbium (Er), lanthanum (La), and samarium (Sm).

The secondary phase material may include at least one selected from the group consisting of magnesium (Mg), manganese (Mn), aluminum (Al), silicon (Si), barium (Ba), titanium (Ti), nickel (Ni), and oxygen (O).

The first and second internal electrodes may include a conductive metal and a ceramic power, the ceramic powder being included in a content of 4.5 wt % to 7.0 wt % based on 100 wt % of the conductive metal.

The first and second internal electrodes may have a thickness of 0.7 μM or less.

The dielectric layer may have a thickness of 0.6 μM or less.

According to another aspect of the present invention, there is provided a multilayer ceramic electronic component, including: a ceramic body having a plurality of dielectric layers laminated therein; and first and second internal electrodes formed with the dielectric layers interposed therebetween, and including a conductive metal and a ceramic powder, wherein the first and second internal electrodes each include a non-electrode region, and on a cross section of the ceramic body taken in length-thickness (L-T) directions thereof, a secondary phase material is formed at interfaces between the first and second internal electrodes and the dielectric layers, and a ratio of an area occupied by the secondary phase material to an overall area of the ceramic body is 0.1% to 0.5%.

The secondary phase material may include a rare earth element.

The rare earth element may be at least one selected from the group consisting of dysprosium (Dy), yttrium (Y), holmium (Ho), erbium (Er), lanthanum (La), and samarium (Sm).

The secondary phase material may include at least one selected from the group consisting of magnesium (Mg), manganese (Mn), aluminum (Al), silicon (Si), barium (Ba), titanium (Ti), nickel (Ni), and oxygen (O).

The first and second internal electrodes may include 4.5 wt % to 7.0 wt % of the ceramic powder based on 100 wt % of the conductive metal.

The first and second internal electrodes may have a thickness of 0.7 μM or less.

The dielectric layer may have a thickness of 0.6 μM or less.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic perspective view showing a multilayer ceramic capacitor according to an embodiment of the present invention;

FIG. 2 is a cross-sectional view schematically showing the multilayer ceramic capacitor taken along line A-A′ of FIG. 1;

FIG. 3 is an enlarged view of part Z of FIG. 2; and

FIG. 4 is a partial enlarged view schematically showing an inside of the multilayer ceramic capacitor according to the embodiment of the present invention.

### DETAILED DESCRIPTION OF THE EMBODIMENTS

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of components may be exaggerated for clarity, and the same reference numerals will be used throughout to designate the same or like components.

An embodiment of the present invention is directed to a multilayer ceramic electronic component, and an electronic component using a ceramic material is a capacitor, an inductor, a piezoelectric element, a varistor, a thermistor, or the like. Hereinafter, a multilayer ceramic capacitor will be described as an example of the multilayer ceramic electronic component.

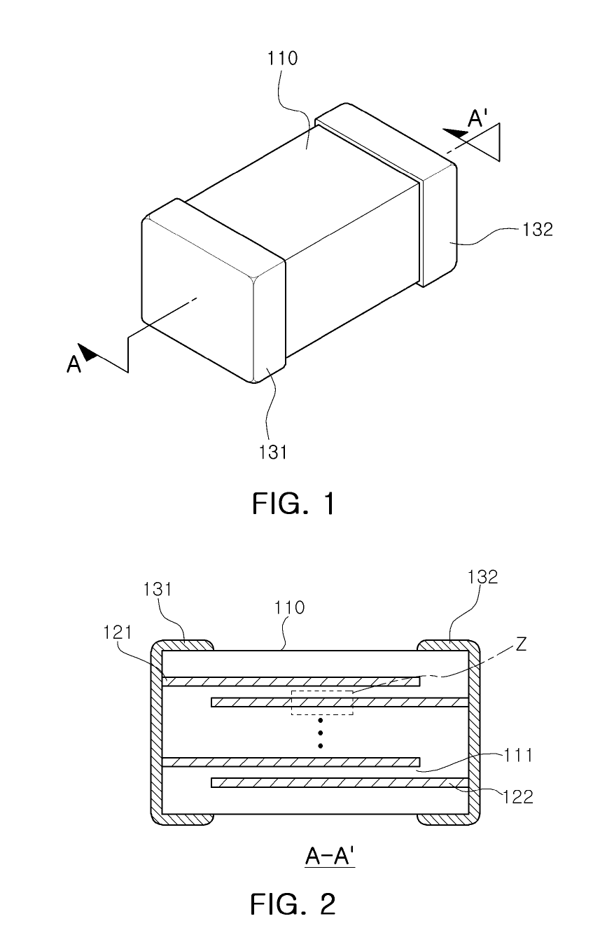

FIG. 1 is a schematic perspective view showing a multilayer ceramic capacitor according to an embodiment of the present invention.

FIG. 2 is a cross-sectional view schematically showing the multilayer ceramic capacitor taken along line A-A′ of FIG. 1.

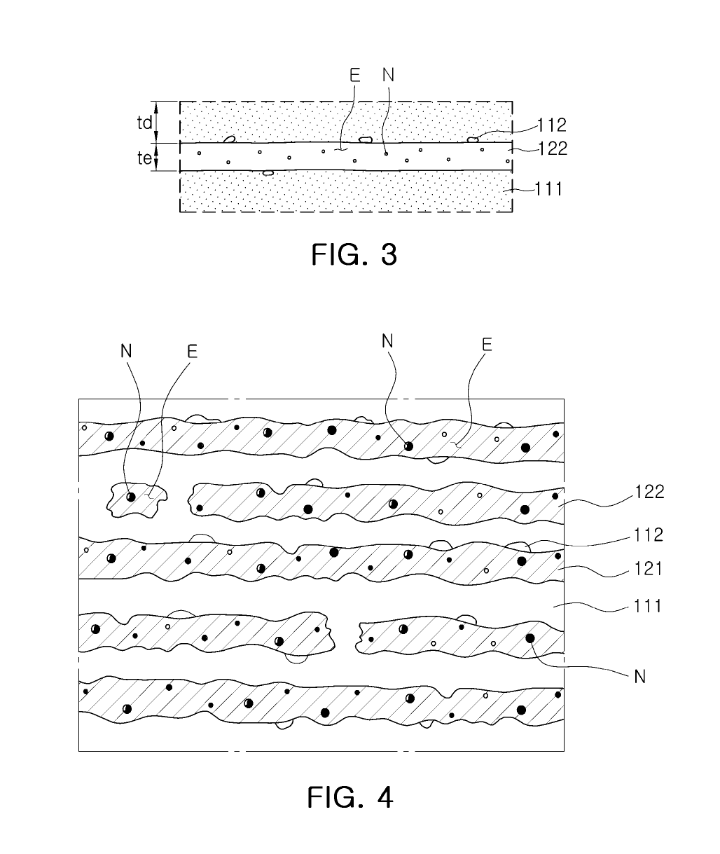

FIG. 3 is an enlarged view of part Z of FIG. 2.

FIG. 4 is a partial enlarged view schematically showing an inside of the multilayer ceramic capacitor according to the embodiment of the present invention.

Referring to FIGS. 1 through 4, a multilayer ceramic capacitor according to the present embodiment may include: a ceramic body 10 including dielectric layers 111; and first and second internal electrodes 121 and 122 formed inside the ceramic body 10 and disposed to face each other having the dielectric layers 111 interposed therebetween; and first and second external electrodes 131 and 132 formed on an external surface of the ceramic body 110.

In the embodiment of the present invention, “length direction”, “width direction”, and “thickness direction”, of the multilayer ceramic capacitor may be defined by ‘L’ direction, ‘W’ direction, and ‘T’ direction in FIG. 1. The ‘thickness direction’ may also refer to a direction in which the dielectric layers are laminated, that is, ‘lamination direction’.

The shape of the ceramic body 110 is not particularly limited, but may be a hexahedral shape in the embodiment of the invention.

The ceramic body 110 may be formed by laminating the plurality of dielectric layers 111.

The plurality of dielectric layers 111 forming the ceramic body 110 are in a sintered state, and may be integrated such that boundaries between adjacent dielectric layers may not be readily apparent.

The dielectric layers 111 may be formed by sintering ceramic green sheets including a ceramic powder.

Any ceramic powder that can be generally used in the art may be employed without particular limitation.

Although not limited thereto, the dielectric layer 111 may include, for example, BaTiO₃ based ceramic powder.

The BaTiO₃ based ceramic powder may be, but is not limited to, (Ba₁₋ₓCaₓ) TiO₃, Ba (Ti_{1-y}Ca_{y}) O₃, (Ba₁₋ₓCaₓ) (Ti_{1-y}Zr_{y}) O₃, Ba (Ti_{1-y}Zr_{y}) O₃, or the like, in which Ca, Zr, or the like is solidified in BaTiO₃.

In addition, the ceramic green sheet may include a transition metal, a rare earth element, magnesium (Mg), aluminum (Al), and the like, in addition to the ceramic powder.

The thickness of the dielectric layer 111 may be appropriately changed according to desired capacitance of the multilayer ceramic capacitor.

For example, the thickness of the dielectric layer 111 formed between two neighboring internal electrodes after sintering may be 0.6 μM or less, but is not limited thereto.

The first and second internal electrodes 121 and 122 may be formed inside the ceramic body 110.

The first and second internal electrodes 121 and 122 may be formed on the ceramic green sheets, be then laminated and sintered, and thus, they may be formed, having one dielectric layer therebetween, inside the ceramic body 110.

The first and second internal electrodes 121 and 122 having different polarities may make a pair, and may be opposed to each other in the lamination direction of the dielectric layers.

As shown in FIG. 2, ends of the first and second internal electrodes 121 and 122 may be alternately exposed to end surfaces of the ceramic body 110 in a length direction thereof.

In addition, although not shown, the first and second internal electrodes according to the embodiment of the invention have lead out portions, respectively, and may be exposed to the same surface of the ceramic body through the lead out portions.

In addition, the first and second internal electrodes 121 and 122 have lead out portions, respectively, and may be exposed to one or more surfaces of the ceramic body through the lead out portions.

The thickness of the first and second internal electrodes 121 and 122 may be appropriately determined depending on the use or the like thereof, and may be, for example, 0.7 μM or less. Alternatively, the thickness of the first and second internal electrodes 121 and 122 may be 0.1 to 0.5 μM. Alternatively, the thickness of the first and second internal electrodes 121 and 122 may be 0.3 to 0.5 μM.

According to the embodiment of the invention, the first and second internal electrodes 121 and 122 may include a conductive metal and a ceramic powder, and the ceramic powder may be included in a content of 4.5 to 7.0 wt % based on 100 wt % of the conductive metal.

A type of the conductive metal for forming the first and second internal electrodes 121 and 122 is not particularly limited, and for example, a base metal may be used.

The conductive metal may include, but is not limited to, for example, at least one of nickel (Ni), manganese (Mn), chrome (Cr), cobalt (Co), aluminum (Al), or an alloy thereof.

In addition, the ceramic powder for the first and second internal electrodes may be the same as the ceramic powder used in the forming of the dielectric layers 111. For example, a barium titanate (BaTiO₃) powder may be used, but the present invention is not limited thereto.

By controlling the content of the ceramic powder included in the first and second internal electrodes 121 and 122, an area of a secondary phase material generated at interfaces between the dielectric layers 111 and the first and second internal electrodes 121 and 122 may be adjusted.

That is, the first and second internal electrodes 121 and 122 include the ceramic powder in a content of 4.5 to 7.0 wt % based on 100 wt % of the conductive metal, so that a ratio of an area occupied by the secondary phase material 112 to an overall area of the ceramic body 110 satisfies 0.1 to 0.5%.

Accordingly, a high-capacitance multilayer ceramic electronic component having excellent reliability may be realized.

If the content of the ceramic powder included in the first and second internal electrodes 121 and 122 is below 4.5 wt % based on 100 wt % of the conductive metal, sintering cracks may occur, resulting in deteriorating reliability.

If the content of the ceramic powder included in the first and second internal electrodes 121 and 122 is above 7.0 wt % based on 100 wt % of the conductive metal, desired capacitance may not be obtained, and thus a high-capacitance multilayer ceramic capacitor may not be realized.

According to the embodiment of the invention, 200 or more dielectric layers having the respective internal electrodes formed thereon may be laminated. A detailed description thereof will be provided below.

According to the embodiment of the invention, the first and second external electrodes 131 and 132 may be formed on an external surface of the ceramic body 110 and may be electrically connected to the first and second internal electrodes 121 and 122.

More specifically, the first external electrode 131 may be electrically connected to the first internal electrodes 121 exposed to one surface of the ceramic body 110 and the second external electrode 132 may be electrically connected to the second internal electrodes 122 exposed to the other surface of the ceramic body 110.

In addition, although not shown, a plurality of external electrodes may be electrically connected to the first and second internal electrodes exposed to the ceramic body.

The first and second external electrodes 131 and 132 may be formed of a conductive paste including a metal powder.

The metal powder included in the conductive paste is not particularly limited, and for example, nickel (Ni), copper (Cu), or an alloy thereof may be used.

The thickness of the first and second external electrodes 131 and 132 may be appropriately determined depending on the use or the like thereof, and may be, for example, 10 to 50 μM.

Referring to FIGS. 2 and 3, in the multilayer ceramic electronic component according to the embodiment of the invention, the dielectric layer 111 may have an average thickness (td) of 0.6 μM or less.

In the embodiment of the invention, the thickness of the dielectric layer 111 may refer to an average thickness of the dielectric layer 111 disposed between the first and second internal electrodes 121 and 122.

The average thickness of the dielectric layer 111 may be measured from an image obtained by scanning a cross section of the ceramic body 110 in the length direction thereof using a scanning electron microscope (SEM), as shown in FIG. 2.

For example, as shown in FIG. 2, the average thickness of the dielectric layer may be obtained by measuring thickness values at 30 equidistant points of the dielectric layer in the length direction thereof, with respect to any dielectric layer extracted from the image obtained by scanning the cross section of the ceramic body 110 in length-thickness (L-T) directions, which is cut in a central portion of the ceramic body 110 in a width (W) direction thereof, using the scanning electron microscope (SEM), and then calculating an average value of the thickness values.

The thickness values at 30 equidistant points may be measured in a capacitance forming part in which the first and second internal electrodes 121 and 122 overlap each other.

The average particle diameter of the ceramic powder used in the forming of the dielectric layer 111 is not particularly limited, and may be controlled in order to achieve the object of the invention, for example, to 400 nm or less.

In the case in which the ultrathin dielectric layer 111 having an average thickness (td) of 0.6 μM or less is used, a reaction may occur at the interfaces between the dielectric layers 111 and the first and second internal electrodes 121 and 122 during sintering, and thus a secondary phase material may be generated. This may cause a reduction in capacitance and the occurrence of sintering cracks, resulting in deteriorating reliability.

The above defects may more frequently occur as the thickness of the first and second internal electrodes 121 and 122 is decreased in order to realize high capacitance.

Therefore, to be described below, on the cross section of the ceramic body 110 in the length-thickness (L-T) directions, the secondary phase material 112 may be formed at the interfaces between the first and second internal electrodes 121 and 122 and the dielectric layers 111, and these defects may be solved by controlling the ratio of the area occupied by the secondary phase material 112 to the overall area of the ceramic body 110 to satisfy 0.1 to 5.0%.

Specifically, when the ratio of the area occupied by the secondary phase material 112 to the overall area of the ceramic body 110 satisfies 0.1 to 0.5%, the capacitance of the multilayer ceramic capacitor may be increased and the occurrence of sintering cracks may be prevented.

For this reason, even in the case in which the ultrathin dielectric layer 111 having the average thickness (td) of 0.6 μm or less is used, a high-capacitance multilayer ceramic electronic component having excellent reliability can be realized.

Referring to FIGS. 2 and 3, in the multilayer ceramic electronic component according to the embodiment of the invention, the first and second internal electrodes 121 and 122 may have an average thickness (te) of 0.7 μM or less.

The average thickness of the first and second internal electrodes 121 and 122 may be measured from the image obtained by scanning the cross section of the ceramic body 110 in the length direction thereof using the scanning electron microscope (SEM), as shown in FIG. 2.

For example, as shown in FIG. 2, the average thickness of the first and second internal electrodes 121 and 122 may be obtained by measuring thickness values at 30 equidistant points of the internal electrode in the length direction thereof, with respect to any first and second internal electrodes 121 and 122 extracted from the image obtained by scanning the cross section of the ceramic body 110 in the length-thickness (L-T) directions, which is cut in the central portion of the ceramic body 110 in the width (W) direction thereof, using the scanning electron microscope (SEM), and then calculating an average value of the thickness values.

The thickness values at 30 equidistant points may be measured in the capacitance forming part in which the first and second internal electrodes 121 and 122 overlap each other.

The average particle diameter of the conductive metal powder used in the forming of the first and second internal electrodes 121 and 122 is not particularly limited, but may be, for example, 400 nm or less.

More specifically, the average particle diameter of the conductive metal powder may be 50 to 400 nm.

In the case in which the ultrathin first and second internal electrodes 121 and 122 having an average thickness (te) of 0.7 μm or less are used, a reaction may occur at the interfaces between the dielectric layers 111 and the first and second internal electrodes 121 and 122 during sintering in the same manner as the foregoing characteristics of the dielectric layers, and thus a secondary phase material may be remarkably generated. This may cause a reduction in capacitance and the occurrence of sintering cracks, resulting in deteriorating reliability.

Therefore, as described below, on the cross section of the ceramic body 110 in the length-thickness (L-T) directions, the secondary phase material 112 may be generated at the interfaces between the first and second internal electrodes 121 and 122 and the dielectric layers 111, and these defects may be solved by controlling the ratio of the area occupied by the secondary phase material 112 to the overall area of the ceramic body 110 to satisfy 0.1 to 0.5%.

Specifically, when the ratio of the area occupied by the secondary phase material 112 to the overall area of the ceramic body 110 satisfies 0.1 to 0.5%, the capacitance of the multilayer ceramic capacitor may be increased and the occurrence of sintering cracks may be prevented.

For this reason, even in the case in which the ultrathin first and second internal electrodes 121 and 122 having the average thickness (te) of 0.7 μM or less are used, a high-capacitance multilayer ceramic electronic component having excellent reliability can be realized.

According to the embodiment of the invention, on the cross section of the ceramic body 110 in the length-thickness (L-T) directions, the secondary phase material 112 may be generated at the interfaces between the first and second internal electrodes 121 and 122 and the dielectric layers 111, and the ratio of the area occupied by the secondary phase material 112 to the overall area of the ceramic body 110 may satisfy 0.1 to 0.5%.

The secondary phase material may include a rare earth element, and for example, the rare earth element may be, but is not limited to, at least one selected from the group consisting of dysprosium (Dy), yttrium (Y), holmium (Ho), erbium (Er), lanthanum (La), and samarium (Sm).

In addition, the secondary phase material may include at least one selected from the group consisting of magnesium (Mg), manganese (Mg), aluminum (Al), silicon (Si), barium (Ba), titanium (Ti), nickel (Ni), and oxygen (O), but is not limited thereto.

The overall area of the ceramic body 110 and the area occupied by the secondary phase material 112 may be measured by scanning the cross section of the ceramic body 110 in the length direction using the scanning electron microscope (SEM), as shown in FIG. 2.

For example, as shown in FIG. 2, the overall area of the ceramic body 110 may be measured from the image obtained by scanning the cross section of the ceramic body 110 in the length-thickness (L-T) directions, which is cut in the central portion of the ceramic body 110 in the width (W) direction, using the scanning electron microscope (SEM), and the area occupied by the secondary phase material 112 may be measured from the extracted image.

When the ratio of the area occupied by the secondary phase material 112 to the overall area of the ceramic body 110 satisfies 0.1 to 0.5%, the reduction in capacitance and the occurrence of sintering cracks due to the secondary phase material generated at the interfaces between the dielectric layers 111 and the first and second internal electrodes 121 and 122 may be prevented.

Accordingly, a high-capacitance multilayer ceramic electronic component having excellent reliability may be realized.

When the ratio of the area occupied by the secondary phase material 112 to the overall area of the ceramic body 110 is below 0.1%, sintering cracks may occur, resulting in deteriorating reliability.

When the ratio of the area occupied by the secondary phase material 112 to the overall area of the ceramic body 110 is above 0.5%, desired capacitance may not be obtained, and thus a high-capacitance multilayer ceramic capacitor may not be realized.

Referring to FIG. 4, the first and second internal electrodes 121 and 122 of the multilayer ceramic capacitor according to the embodiment of the invention may include a non-electrode region (N).

According to the embodiment of the invention, a portion of the first and second internal electrodes 121 and 122 with the exception of the non-electrode region (N) may be referred to as an electrode region (E).

According to the embodiment of the invention, the non-electrode region (N) may be formed during the sintering of the first and second internal electrodes, and the non-electrode region (N) may be formed by a conductive paste composition for forming the internal electrodes.

The non-electrode region (N) may include, but is not limited to, a ceramic component.

According to the embodiment of the invention, the non-electrode region (N) may be formed of a component included in the conductive paste which is not the conductive metal included therein, and may be formed of, for example, a ceramic powder.

In addition, a material for forming the non-electrode region (N) may be, for example, a ceramic additive powder, a binder, a solvent, and the like.

The binder and the solvent may be present as a carbon based component remaining by sintering. In addition, the non-electrode region (N) may be formed as a pore.

A multilayer ceramic electronic component according to another embodiment of the invention may include: a ceramic body 110 having a plurality of dielectric layers 111 laminated therein; and first and second internal electrodes 121 and 122 having the dielectric layer 111 interposed therebetween, and including a conductive metal and a ceramic powder, wherein the first and second internal electrodes 121 and 122 include a non-electrode region N, and wherein, on a cross section of the ceramic body 110 in length-thickness (L-T) directions, a secondary phase material 112 is formed at interfaces between the first and second internal electrodes 121 and 122 and the dielectric layers 111 and a ratio of an area occupied by the secondary phase material 112 to an overall area of the ceramic body 110 is 0.1 to 0.5%.

The secondary phase material may include a rear earth element.

The rare earth element may be at least one selected from the group consisting of dysprosium (Dy), yttrium (Y), holmium (Ho), erbium (Er), lanthanum (La), and samarium (Sm).

The secondary phase material may include at least one selected from the group consisting of magnesium (Mg), manganese (Mn), aluminum (Al), silicon (Si), barium (Ba), titanium (Ti), nickel (Ni), and oxygen (O).

The first and second internal electrodes may include the conductive metal and the ceramic powder, and the ceramic powder may be included in a content of 4.5 to 7.0 wt % based on 100 wt % of the conductive metal.

The thickness of the first and second internal electrodes may be 0.7 μM or less.

The thickness of the dielectric layer may be 0.6 μM or less.

The characteristics of the multilayer ceramic electronic component according to another embodiment of the present invention are the same as those of the multilayer ceramic electronic component according to the above-described embodiment of the present invention, and herein, overlap descriptions thereof will be omitted.

Hereinafter, a method of manufacturing a multilayer ceramic capacitor according to an embodiment of the invention will be described.

According to the embodiment of the invention, a plurality of ceramic green sheets may be prepared. The ceramic green sheets may be fabricated by mixing a ceramic powder, a binder, a solvent, and the like to prepare a slurry, and molding the slurry as a sheet having a thickness of several μm using a doctor blade method. The ceramic green sheet may be then sintered to form one dielectric layer 111 shown in FIG. 2.

Then, a conductive paste for internal electrodes may be coated on the ceramic green sheets to form internal electrode patterns on the ceramic green sheets, respectively. The internal electrode patterns may be formed by a screen printing method or a gravure printing method.

The conductive paste for internal electrodes may further include a binder, a solvent, and other additives.

Examples of the binder may include, but are not limited to, polyvinylbutyral, cellulose based resin, and the like.

The polyvinylbutyral may enhance adhesive strength between the conductive paste and the ceramic green sheet.

The cellulose based resin has a chair structure, and elastic recovery thereof is fast when it is transformed.

The inclusion of the cellulose resin may secure a flat print surface.

Examples of the solvent are not particularly limited, and may be butylcarbitol, kerosene, or terpineol based solvent.

Specific examples of the terpineol based solvent may include, but are not limited to, dihydro terpineol, dihydro terpinyl acetate, and the like.

Thereafter, the ceramic green sheets on which the internal electrode patterns are respectively formed are laminated, and pressed and compressed in a lamination direction.

Therefore, a ceramic laminate having the internal electrode patterns formed therein may be manufactured.

Then, the ceramic laminate may be cut for each region corresponding to one capacitor, thereby forming respective chips.

Here, the cutting of the ceramic laminate may be performed while allowing one ends of the internal electrodes to be alternately exposed through end surfaces of the ceramic laminate.

Then, the laminate having the form of the chip is sintered to manufacture a ceramic body.

The sintering process may be performed in a reducing atmosphere.

In addition, the sintering process may be performed by controlling a temperature rise rate.

The temperature rise rate may be, but is not limited to, 30° C./60 s to 50° C./60 s.

Then, external electrodes may be formed to cover the end surfaces of the ceramic body and be electrically connected to the internal electrodes exposed to the end surfaces of the ceramic body.

Thereafter, surfaces of the external electrodes may be subjected to a plating process using nickel, tin, or the like.

Table 1 below shows occurrence or non-occurrence of cracks after sintering and realization or non-realization of desired capacitance, depending on the ratio of the area occupied by the secondary phase material 112 to the overall area of the ceramic body 110.

TABLE 1

| | Ratio of Area Occupied | Occurrence or | Realization or |
|---|---|---|---|
| | by Secondary Phase | Non-Occurrence | Non-Realization |
| Sam- | Material to Overall | of Cracks After | of Desired |
| ple | Area of Ceramic Body (%) | Sintering | Capacitance |
| *1 | 0.05 | ∘ | ∘ |
| *2 | 0.08 | ∘ | ∘ |
| 3 | 0.1 | x | ∘ |
| 4 | 0.2 | x | ∘ |
| 5 | 0.3 | x | ∘ |
| 6 | 0.4 | x | ∘ |
| 7 | 0.5 | x | ∘ |
| *8 | 0.52 | x | x |
| *9 | 0.55 | x | x |
| *10 | 0.6 or higher | x | x |

*Comparative Examples
∘: Occurrence of cracks after sintering, actual capacitance as compared with desired capacitance: 90% or higher
x: Non-occurrence of cracks after sintering, actual capacitance as compared with desired capacitance: below 90%

It may be seen from Table 1 that in Samples 1 and 2 (comparative examples) in which the ratio of the area occupied by the secondary phase material 112 to the overall area of the ceramic body 110 was below 0.1%, cracks occurred after sintering, resulting in deteriorating reliability.

Also, it may be seen that in Samples 8 to 10 (comparative examples) in which the ratio of the area occupied by the secondary phase material 112 to the overall area of the ceramic body 110 was above 0.5%, desired capacitance was not obtained.

It may be seen that in Samples 3 to 7 (inventive examples of the present invention) in which the numerical range of the present invention was satisfied, cracks did not occur after sintering and desired capacitance was obtained, and thus, a high-capacitance multilayer ceramic capacitor having excellent reliability may be realized.

Table 2 below shows occurrence or non-occurrence of cracks after sintering and realization or non-realization of desired capacitance, depending on the content of the ceramic powder included in the first and second internal electrodes 121 and 122.

TABLE 2

| | | Content of | Ratio of Area Occupied | Number of Cracks | Realization or |
|---|---|---|---|---|---|
| | Ni (Ni) | Ceramic Powder | by Secondary Phase | Occurred | Non-Realization of |
| Sam- | Content | to Ni (Ni) | Material to Overall | After | Desired |
| ple | (wt %) | (wt %/Ni) | Area of Ceramic Body (%) | Sintering | Capacitance |
| *1 | 45~55 | Below 2.0 | Below 0.05 | 3/100 | x |
| *2 | | 3.0~4.5 | Below 0.08 | 2/100 | x |
| 3 | | 4.5~5.0 | 0.1 | 0/100 | ∘ |
| 4 | | 5.0~5.5 | 0.2 | 0/100 | ∘ |
| 5 | | 5.5~6.0 | 0.3 | 0/100 | ∘ |
| 6 | | 6.0~6.5 | 0.4 | 0/100 | ∘ |
| 7 | | 6.5~7.0 | 0.5 | 0/100 | ∘ |
| *8 | | 7.0~8.0 | 0.52 | 0/100 | x |
| *9 | | 8.0~9.0 | 0.55 | 0/100 | x |
| *10 | | Above 9.0 | 0.60 | 0/100 | x |

*Comparative Example
∘: Actual capacitance as compared with desired capacitance: 90% or higher
x: Actual capacitance as compared with desired capacitance: below 90%

It may be seen from Table 2 that in Samples 1 and 2 (comparative examples) in which the content of ceramic powder based on 100 wt % of the conductive metal was below 4.5 wt %, cracks occurred, and thus reliability was deteriorated and desired capacitance was not obtained.

Also, it may be seen that in Samples 8 to 10 (comparative examples) in which the content of ceramic powder based on 100 wt % of the conductive metal was above 7.0 wt %, desired capacitance was not obtained.

It may be seen that in Samples 3 to 7 (inventive examples of the present invention) in which the numerical range of the present invention was satisfied, cracks did not occur after sintering and desired capacitance was obtained, and thus, a high-capacitance multilayer ceramic capacitor having excellent reliability may be realized.

As set forth above, according to the embodiments of the invention, a high-capacitance multilayer ceramic capacitor can be realized by controlling the area of the secondary phase material formed at the interfaces between the internal electrodes and the dielectric layers.

Further, according to the embodiments of the invention, defects in the inner structure of the multilayer ceramic electronic component, such as cracks after sintering, can be prevented, resulting in excellent reliability.

While the present invention has been shown and described in connection with the embodiments, it will be apparent to those skilled in the art that modifications and variations can be made without departing from the spirit and scope of the invention as defined by the appended claims.

What is claimed is:

1. A multilayer ceramic electronic component, comprising:
a ceramic body including dielectric layers; and
first and second internal electrodes formed inside the ceramic body and disposed to face each other with the dielectric layer interposed therebetween,
wherein, on a cross section of the ceramic body taken in length-thickness (L-T) directions thereof, a secondary phase material is formed at interfaces between the first and second internal electrodes and the dielectric layers, and a ratio of an area occupied by the secondary phase material to an overall area of the ceramic body is 0.1% to 0.5%.

2. The multilayer ceramic electronic component of claim 1, wherein the secondary phase material includes a rare earth element.

3. The multilayer ceramic electronic component of claim 2, wherein the rare earth element is at least one selected from the group consisting of dysprosium (Dy), yttrium (Y), holmium (Ho), erbium (Er), lanthanum (La), and samarium (Sm).

4. The multilayer ceramic electronic component of claim 1, wherein the secondary phase material includes at least one selected from the group consisting of magnesium (Mg), manganese (Mn), aluminum (Al), silicon (Si), barium (Ba), titanium (Ti), nickel (Ni), and oxygen (O).

5. The multilayer ceramic electronic component of claim 1, wherein the first and second internal electrodes include a conductive metal and a ceramic power, the ceramic powder being included in a content of 4.5 wt % to 7.0 wt % based on 100 wt % of the conductive metal.

6. The multilayer ceramic electronic component of claim 1, wherein the first and second internal electrodes have a thickness of 0.7 μM or less.

7. The multilayer ceramic electronic component of claim 1, wherein the dielectric layer has a thickness of 0.6 μm or less.

8. A multilayer ceramic electronic component, comprising:
a ceramic body having a plurality of dielectric layers laminated therein; and
first and second internal electrodes formed with the dielectric layer interposed therebetween, and including a conductive metal and a ceramic powder,
wherein the first and second internal electrodes include a non-electrode region, and
on a cross section of the ceramic body taken in length-thickness (L-T) directions thereof, a secondary phase material is formed at interfaces between the first and second internal electrodes and the dielectric layers, and a ratio of an area occupied by the secondary phase material to an overall area of the ceramic body is 0.1% to 0.5%.

9. The multilayer ceramic electronic component of claim 8, wherein the secondary phase material includes a rare earth element.

10. The multilayer ceramic electronic component of claim 9, wherein the rare earth element is at least one selected from the group consisting of dysprosium (Dy), yttrium (Y), holmium (Ho), erbium (Er), lanthanum (La), and samarium (Sm).

11. The multilayer ceramic electronic component of claim 8, wherein the secondary phase material includes at least one selected from the group consisting of magnesium (Mg), manganese (Mn), aluminum (Al), silicon (Si), barium (Ba), titanium (Ti), nickel (Ni), and oxygen (O).

12. The multilayer ceramic electronic component of claim 8, wherein the first and second internal electrodes include 4.5 wt % to 7.0 wt % of the ceramic powder based on 100 wt % of the conductive metal.

13. The multilayer ceramic electronic component of claim 8, wherein the first and second internal electrodes have a thickness of 0.7 μM or less.

14. The multilayer ceramic electronic component of claim 8, wherein the dielectric layer has a thickness of 0.6 μM or less.
